(19) United States
(12) Patent Application Publication
(10) Pub. No.: US 2005/0265374 A1
(43) Pub. Date: Dec. 1, 2005

(54) Broadband telecommunication system and method used therein to reduce the latency of channel switching by a multimedia receiver

(75) Inventor: Michiel Pelt, Grimbergen (BE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/130,142

(22) Filed: May 17, 2005

(30) Foreign Application Priority Data
May 28, 2004 (EP) 04291359.0

(51) Int. Cl. H04L 12/56

(52) U.S. Cl. 370/437; 370/401

(57) ABSTRACT

A broadband telecommunication system with several content servers (BS1-4) providing channels of multimedia data to subscribers (TV1-4) coupled thereto via a access unit, preferably an Asymmetric Digital Subscriber Line (ADSL) Subscriber Access Multiplexer (ASAM). The content servers are also coupled to the ADSL Subscriber Access Multiplexer (ASAM) via a Zapping Service Box (ZSB) that merges the channels into a composed channel transmitted to the ASAM via a single zapping channel (ZC). When a subscriber (TV3) requests a selected channel, and when this channel is not yet directly available at the ASAM, the latter immediately provides to this subscriber the composed channel until the ASAM receives the requested channel directly from the content server providing it.

The present invention relates to a method used in a broadband telecommunication system wherein several content servers are coupled to a plurality of subscribers via an access unit for providing to a subscriber of said plurality, and upon request of said subscriber, a selected channel selected by said subscriber.

Such a method used in a broadband telecommunication system is generally known in the art. It relates to multicast delivery that encounters a problem of long and unpredictable latency when the subscriber, or rather the user thereof, changes from one multicast group, i.e. a channel, to another. This latency or delay is particular disturbing for services like broadcast video.

The longer the latency, the longer the subscriber or user will receive an unwanted channel or multicast traffic until the moment the requested channel can be forwarded. This reduces the user experience since people watching television like to zap, i.e. to switch from one channel to another. By zapping, sequentially another channel is selected and viewed for a certain time.

The latency originates from various sources:

1. Protocols used between the access unit, which is preferably an ADSL Subscriber Access Multiplexer (ASAM), and the subscriber or host, such as the Internet Group Management Protocol (IGMP) or the Multicast Listener Discovery (MLD). For instance in case of IGMPv2 (IGMP version 2), a host can send a leave message and a join message when the user connected thereto wants to change to another channel. A leave message informs the access unit not to forward its traffic anymore. A join message informs the access unit to forward another channel. Especially the leave message introduces latency since an access unit cannot decide instantly to stop forwarding the traffic in case other hosts are also members of this multicast group over a same interface. However, in case an access unit keeps “stateful” data (of a forwarding table) on the host memberships at every interface, this does not apply. Alternatively, for IGMPv3 the zapping speed will improve significantly since a single message is sent to the access unit that tells it to stop forwarding one channel and to forward another. This decreases the latency significantly. However, time is still required before an access unit decides to block one channel and to forward the newly requested channel.

2. The transfer of content from the content servers up to the access unit:
The access unit already receives the requested multicast stream (can be statically configured). In this case, the access unit will instantly forward the multicast traffic over the interfaces specified by the above mentioned protocols used between the access unit and the subscribers, or
The access unit does not yet receive the requested multicast stream. In this case, the access unit is a multicast router and uses multicast routing protocols to assure to receive the requested stream. This does not occur instantly and introduces a latency that may depend on the network load and other unpredictable situations.

3. Even when no latency occurs due to protocols, as described above, an unpredictable latency may occur when zapping. For instance, when too many hosts on a network simultaneously demand for another multicast group, i.e. in case of a peak of the number of zaps per second. This is a very realistic scenario occurring for instance during a publicity break in a soccer game or a movie. At that moment, the available resources to inspect the IGMP traffic from all hosts on the network at line rate may not be sufficient, because of lack of CPU processing power.

It is also to be noted that the deployment of IGMPv3 (IGMP version 3) does not exclude IGMPv2. If on a network a single host uses IGMPv2, all other IGMPv3 hosts and routers will fall back to IGMPv2 since IGMPv3 has to be backward compatible with IGMPv2.

Proprietary solutions exist to reduce the latency of zapping. The Alcatel™ ASAM, for instance, performs IGMP snooping whereby a predefined set of multicast channels is statically configured and available to be forwarded using a point-to-multipoint ATM connection. This reduces the latency for channel zapping significantly since:
the ASAM does not have to use multicast routing protocols to fetch the requested multicast stream, and
the latency is limited to the performance in the access loop (IGMP messages do not go beyond the ASAM).

However, this also introduces some limitations:
xDSL subscribers cannot select other than those that are configured, and
in case all subscribers zap simultaneously then the maximum number of zaps per seconds is reached. The ASAM will not be able to process all these requests simultaneously.

An object of the present invention is to provide a method used in a broadband telecommunication system as mentioned above but wherein the latency encountered by a subscriber that wants to switch to another channel is dramatically reduced.

According to the invention, this object is achieved due to the fact that said method comprises the step of, upon said subscriber requesting the selected channel, immediately providing to said subscriber a composed channel containing channels transmitted by a plurality of said content servers and including a second channel substantially identical to said selected channel.

In this way, by a channel swapping, the newly requested selected channel is immediately provided to the subscriber under the form of the second channel.

Another characterizing embodiment of the present invention is that the channels transmitted by said plurality of content servers are merged into said composed channel by a Zapping Service Box prior to be transferred to the subscriber.

In other words, multiple streaming channels are fed to the Zapping Service Box that converts in real time a predefined set of multicast streams into a single stream or composed channel. The composed channel is transmitted on a zapping channel that is broadcasted to the subscribers via the access unit or ASAM. If the ASAM detects that a subscriber is no longer interested in receiving a channel, e.g. under the form of a leave message in case of IGMPv2, it forwards the zapping channel towards this subscriber. In meanwhile, the processing of the request is processed further in the background.

The present invention further relates to a broadband telecommunication system with several content servers coupled to a plurality of subscribers via an access unit.

The subscribers of such a known broadband telecommunication system suffers from the above-mentioned latency problems when requesting to change there coupling to another content server.

A further object of the present invention is to provide a broadband telecommunication system of the above known type but wherein the switching latency experienced by the subscribers is dramatically reduced.

According to the invention, this object is achieved due to the fact that said content servers are coupled to the access unit directly and via a Zapping Service Box adapted to merge channels received from a plurality of said content servers into a composed channel transmitted to said access unit on a single zapping channel.

In this way, and as it will become clear later from the description of the invention, the above latency is reduced by coupling the subscriber to the single zapping channel until the newly requested channel is available at the access unit, that is preferably an ADSL Subscriber Access Multiplexer (ASAM), and so further at the subscriber.

In more detail, said access unit is adapted to connect a subscriber to said zapping service box prior to connect said subscriber to a content server from which said subscriber requests receiving a channel.

Still another characterizing embodiment of the present invention is that the composed channel transmitted on said single zapping channel between said zapping service box and said access unit contains a second channel substantially identical to the channel requested by said subscriber.

The subscriber is coupled the access unit or ADSL Subscriber Access Multiplexer (ASAM) in order to receive this second channel until the new channel is available.

Further characterizing embodiments of the present broadband telecommunication system and the method used therein are mentioned in the appended claims.

It is to be noticed that the term ‘comprising’, used in the claims, should not be interpreted as being restricted to the means listed thereafter. Thus, the scope of the expression ‘a device comprising means A and B’ should not be limited to devices consisting only of components A and B. It means that with respect to the present invention, the only relevant components of the device are A and B.

Similarly, it is to be noticed that the term ‘coupled’, also used in the claims, should not be interpreted as being restricted to direct connections only. Thus, the scope of the expression ‘a device A coupled to a device B’ should not be limited to devices or systems wherein an output of device A is directly connected to an input of device B. It means that there exists a path between an output of A and an input of B which may be a path including other devices or means.

The above and other objects and features of the invention will become more apparent and the invention itself will be best understood by referring to the following description of an embodiment taken in conjunction with the accompanying drawings wherein:

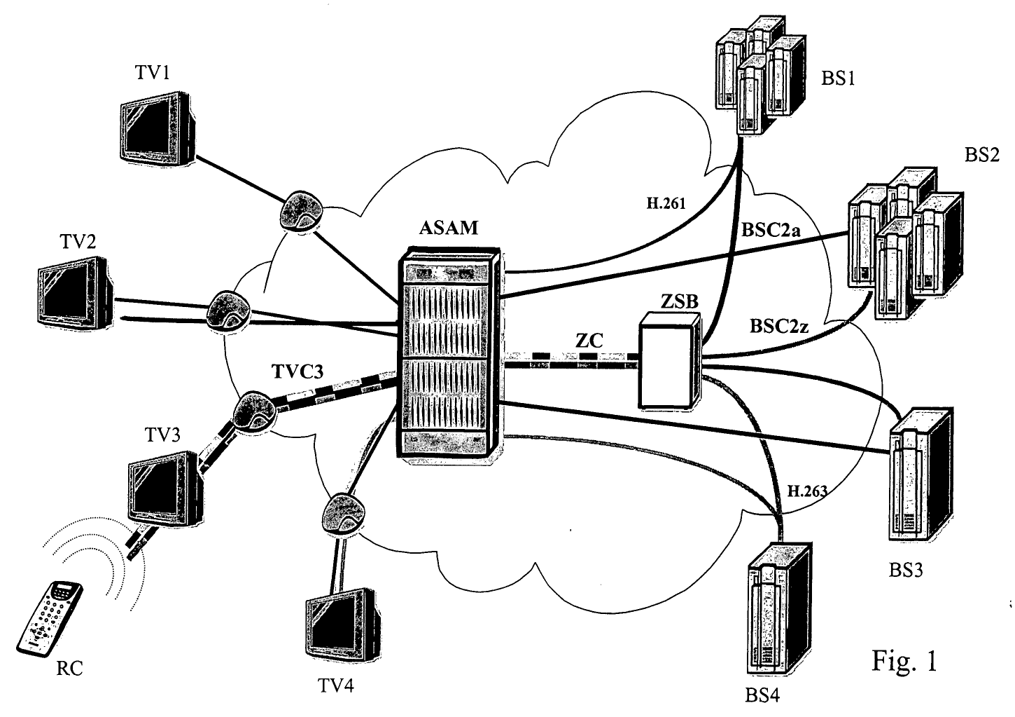

FIG. 1 represents a broadband telecommunication system with a Zapping Service Box (ZSB) and an ADSL Subscriber Access Multiplexer (ASAM) interconnected and operating according to the invention; and

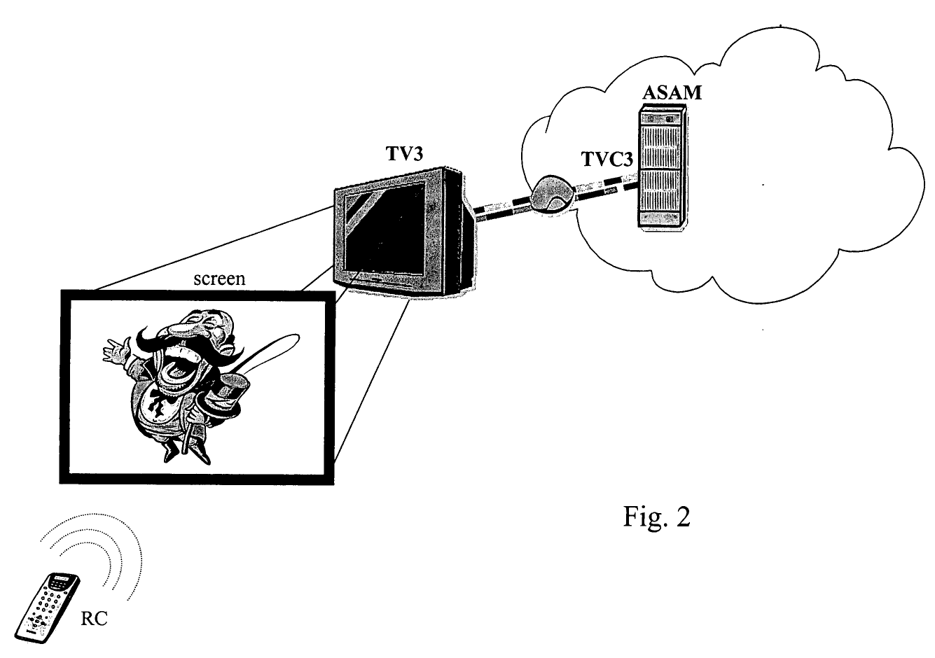

FIG. 2 represents the transmission of a view received on the screen of a subscriber (TV3) from the zapping service box and via the ADSL Subscriber Access Multiplexer (ASAM) of FIG. 1.

The broadband telecommunication system shown at FIG. 1 comprises several content servers BS1 to BS4 coupled to several subscribers TV1 to TV4 via broadband channels. The system further comprises an access unit, that is preferably an Asymmetric Digital Subscriber Line (ADSL) Subscriber Access Multiplexer ASAM, and that interfaces the content servers BS1-4 with the subscribers TV1-4. A content server BS1/4 provides a channel of multimedia data from groups such as for instance BBC™ or CNN™, and a subscriber, e.g. TV3, may select receiving multimedia data from one of these content servers by means of a remote controller RC.

When a subscriber (or the user thereof), e.g. TV3, selects a channel from a content server, e.g. BS2, multimedia data is transmitted from the content server BS2 to the ADSL subscriber access multiplexer ASAM via a channel BSC2a and so further to the subscriber TV3 via a channel TVC3. Most of the multimedia data from the content servers BS1-4 are available at the ASAM so that the latter can immediately provide the requested data to the subscriber selecting it, e.g. by zapping on the remote controller RC. However, in case a requested (selected) multimedia data is not available at the ASAM, the subscriber has to wait prior to receive the expected multimedia data. To reduce this latency, the content servers BS1-4 are also coupled, e.g. via the channel BSC2z for the content server BS2, to a zapping service box ZSB that merges the received multimedia data into a composed channel ZC prior to transfer it to the ADSL subscriber access multiplexer ASAM via a like-named single zapping channel ZC.

In case a subscriber selects a channel from a content server of which the multimedia data is not yet available at the ASAM, the latter first transmits immediately the zapping channel ZC to this subscriber, e.g. as the screen view shown at FIG. 2, until the multimedia data is directly received at the ASAM from the selected content server.

It is to be noted that several zapping service boxes may be provided in the broadband telecommunication system.

The operation of the broadband telecommunication system with a zapping service box ZSB will be explained in more detail below.

The zapping service box ZSB is a member of a predefined set of multicast groups, e.g. BBC™ or CNN™. As a consequence ZSB receives the multicast traffic of multiple sources BS1-4 in different formats and converts them in real time into a single channel ZC. Besides building this single stream, ZSB has to reduce the quality of the different multicast channels because of the limited bitrate of the outgoing zapping channel ZC. Indeed, the bitrate of the zapping channel ZC must fit to the bandwidth constraints of the broadband connection of the subscribers TV1-4. To that aim, a balance is fixed in-between:
the number of streams converted into the zapping channel ZC, and
the bitrate of the individual stream to assure sufficient quality to degrade the user experience not too much.

The zapping channel ZC is forwarded by the zapping service box ZSB towards each ASAM of the broadband telecommunication system.

Once the ASAM detects that the subscriber TV3 wants to change to the channel of BS2, the ASAM immediately forwards the zapping channel ZC without any delay to TV3. The subscriber TV3 receives then the set of predefined channels from the zapping service box ZCB.

Since the zapping channel ZC is instantly forwarded by the ASAM, the subscriber TV3 receives with minimum latency the channel he requested but temporary with less quality. If the subscriber in meanwhile zaps again, and if this new channel is present in the zapping channel ZC, the subscriber can switch to this new channel again without any latency.

It is to be noted that the channel selected by the subscriber TV3 may be extracted from the zapping channel ZC either at the level of the ASAM or at the level of the subscriber itself, e.g. by means of a so-called Set-Top Box (not shown) well known in the art.

Since the zapping channel is forwarded instantly upon detection of an IGMP leave message, there is no faster way possible to respond to the subscriber. In prior art, the leave message has to travel towards the access unit or a box performing IGMP snooping. These devices have to investigate the message before to take any action.

In case the subscriber zaps again, it can immediately switch to another channel inside the zapping channel.

Owing to the zapping service box ZCB time is bought to do processing and to direct the requested multicast traffic towards the subscriber. This avoids dedicating resources to handle a maximum number of zaps per seconds that is rarely used, i.e. when all subscribers simultaneously would zap.

Moreover, instead of sequentially selecting one multicast channel after the other, multiple channels are present in the zapping channel ZC, and the latter is only forwarded once to the subscriber. This avoids that multicast traffic in unnecessary forwarded from the content server up to the subscribers in case a subscriber immediately zaps again.

Furthermore, multicast channels do not have to be statically configured at the ASAM to reduce latency. Some “premium” channels can be offered instantaneously in the zapping channel ZC whereas other channels can be offered after a longer latency time.

In a further application, the zapping channel ZC can be considered as preview channel for available from which a subscriber can select what he wants to see.

A final remark is that embodiments of the present invention are described above in terms of functional blocks. From the functional description of these blocks, given above, it will be apparent for a person skilled in the art of designing electronic devices how embodiments of these blocks can be manufactured with well-known electronic components. A detailed architecture of the s of the functional blocks hence is not given.

While the principles of the invention have been described above in connection with specific apparatus, it is to be clearly understood that this description is merely made by way of example and not as a limitation on the scope of the invention, as defined in the appended claims.

1. A method used in a broadband telecommunication system wherein several content servers (BS1-4) are coupled to a plurality of subscribers (TV1-4) via at least one access unit (ASAM) for providing to a subscriber (TV3) of said plurality, and upon request of said subscriber, a channel (BSC2a) selected by said subscriber amongst a plurality of available channels,
characterized in that said method comprises the step of, upon said subscriber (TV3) requesting the selected channel, immediately providing to said subscriber a composed channel (ZC) containing channels transmitted by a plurality of said content servers (BS1-4) and including a second channel (BSC2z) substantially identical to said selected channel (BSC2a).

2. The method according to claim 1, characterized in that the channels transmitted by said plurality of content servers (BS1-4) are merged into said composed channel (ZC) by a Zapping Service Box (ZSB) prior to be transferred to the subscriber.

3. The method according to claim 1, characterized in that said method further comprises the step of transmitting said composed channel (ZC) to said subscriber (TV3) until the access unit (ASAM) receives directly said selected channel (BSC2a) from a content server.

4. The method according to claim 3, characterized in that, when the access unit (ASAM) receives directly said selected channel (BSC2a), said selected channel is transmitted to said subscriber (TV3) rather than said composed channel (ZC).

5. The method according to claim 1, characterized in that said method further comprises the steps of extracting said second channel (BSC2z) from said composed channel (ZC) and of transmitting the extracted second channel to said subscriber (TV3) until the access unit (ASAM) receives directly said selected channel (BSC2a).

6. The method according to claim 5, characterized in that, when the access unit (ASAM) receives directly said selected channel (BSC2a), said selected channel is transmitted to said subscriber (TV3) rather than said second channel (BSC2z).

7. The method according to claim 6, characterized in that the steps of
extracting the second channel (BSC2z) from the composed channel (ZC),
transmitting the extracted second channel to the subscriber (TV3), and
transmitting the selected channel to the subscriber instead of the second channel
are performed by a Set-Top Box (STB) located at the premises of the subscriber.

8. The method according to claim 2, characterized in that said composed channel is transmitted from said Zapping Service Box (ZSB) to said access unit (ASAM) on a single channel (ZC) and in that said composed channel is always available at said access unit.

9. The method according to claim 1, characterized in that said second channel (BSC2z) and said selected channel (BSC2a) are transmitted by a same content server.

10. The method according to claim 1, characterized in that said second channel (BSC2z) is of lower quality than said selected channel (BSC2a).

11. The method according to claim 1, characterized in that said access unit is an Asymmetric Digital Subscriber Line (ADSL) Subscriber Access Multiplexer (ASAM).

12. A broadband telecommunication system with several content servers (BS1-4) coupled to a plurality of subscribers (TV1-4) via an access unit (ASAM),
characterized in that said content servers (BS1-4) are coupled to the access unit (ASAM) directly and via a Zapping Service Box (ZSB) adapted to merge channels received from a plurality of said content servers into a composed channel transmitted to said access unit on a single zapping channel (ZC).

13. The broadband telecommunication system according to claim 12, characterized in that said Zapping Service Box (ZSB) is included in said access unit (ASAM).

14. The broadband telecommunication system according to claim 12, characterized in that said access unit (ASAM) is adapted to connect a subscriber (TV3) to said zapping service box (ZSB) prior to connect said subscriber (TV3) to a content server (BS2) from which said subscriber requests receiving a channel (BSC2a).

15. The broadband telecommunication system according to claim 12, characterized in that the composed channel transmitted on said single zapping channel (ZC) between said zapping service box (ZSB) and said access unit (ASAM) contains a second channel (BSC2z) substantially identical to the channel (BSC2a) requested by said subscriber (TV3).

16. The broadband telecommunication system according to claim 12, characterized in that said subscriber (TV3) is a multimedia receiver, and in that said channels (BSC2a, BSC2z) form multicast traffic.

17. The broadband telecommunication system according to claim 12, characterized in that said access unit is an Asymmetric Digital Subscriber Line (ADSL) Subscriber Access Multiplexer (ASAM).
